(19) United States
(12) Patent Application Publication
(10) Pub. No.: US 2026/0134851 A1
(43) Pub. Date: May 14, 2026

(54) METHOD FOR PROVIDING COLOR INFORMATION, AND ELECTRONIC DEVICE FOR SUPPORTING SAME

(71) Applicant: Samsung Electronics Co., Ltd., Suwon-si (KR)

(72) Inventors: Jongah KIM, Suwon-si (KR); Heewoong YOON, Suwon-si (KR); Kihyuk LEE, Suwon-si (KR); Donghan LEE, Suwon-si (KR); Gwangho CHOI, Suwon-si (KR)

(21) Appl. No.: 19/442,585

(22) Filed: Jan. 7, 2026

Related U.S. Application Data
(63) Continuation of application No. PCT/KR2024/010458, filed on Jul. 19, 2024.

(30) Foreign Application Priority Data
Sep. 4, 2023 (KR) 10-2023-0117088
Sep. 27, 2023 (KR) 10-2023-0130759

(51) Int. Cl. G09G 5/10; G09G 5/02

(52) U.S. Cl. CPC G09G 5/10; G09G 5/02; G09G 2320/0626; G09G 2330/021; G09G 2360/145; G09G 2380/02

(57) ABSTRACT

An electronic device is provided. The electronic device includes a first display, a first display driver integrated circuit (DDI) capable of controlling the first display and acquiring color information, a second display, a second DDI for controlling the second display, a first illuminance sensor disposed under a first region of the first display, a second illuminance sensor disposed under a second region of the second display, and at least one processor operatively connected to the first display, the first DDI, the second display, the second DDI, the first illuminance sensor and the second illuminance sensor. The first DDI can acquire information about an image from the second DDI on the basis of acquiring an input for displaying the image through the second display, acquire color information of a portion corresponding to the second region of the second display in the image on the basis of the acquired information about the image, and, on the basis of the acquired color information and an illuminance value acquired through the second illuminance sensor when the image is displayed through the second display, provide the acquired color information to the at least one processor such that the at least one processor adjusts the luminance of the second display.

### CROSS-REFERENCE TO RELATED APPLICATION(S)

This application is a continuation application, claiming priority under 35 U.S.C. § 365 (c), of an International application No. PCT/KR2024/010458, filed on Jul. 19, 2024, which is based on and claims the benefit of a Korean patent application number 10-2023-0117088, filed on Sep. 4, 2023, in the Korean Intellectual Property Office, and of a Korean patent application number 10-2023-0130759, filed on Sep. 27, 2023, in the Korean Intellectual Property Office, the disclosure of each of which is incorporated by reference herein in its entirety.

### BACKGROUND

### 1. Field

The disclosure relates to a method for providing color information and an electronic device supporting the same.

### 2. Description of Related Art

An electronic device may measure an illuminance (e.g., an illuminance value of external light) of the environment in which the electronic device is positioned through an illuminance sensor. The electronic device may adjust the luminance of the display based on the illuminance measured through the illuminance sensor.

The illuminance sensor may be placed under the display (e.g., the rear surface of the display) when viewed from the front surface (e.g., the surface where the display of the electronic device is exposed) of the electronic device. As a result, the illuminance value measured by the illuminance sensor may include an illuminance value affected by external light incident from outside the electronic device (hereinafter referred to as “external light”), and an illuminance value affected by light emitted from the display (hereinafter referred to as “display light”) (hereinafter also referred to as “display light estimation value”). Accordingly, the electronic device may obtain (e.g., calculate) an illuminance value affected by external light incident from outside the electronic device by subtracting the illuminance value affected by display light from the illuminance value measured through the illuminance sensor (hereinafter also referred to as “compensating the illuminance value”).

The above information is presented as background information only to assist with an understanding of the disclosure. No determination has been made, and no assertion is made, as to whether any of the above might be applicable as prior art with regard to the disclosure.

### SUMMARY

The display light estimation value affected by display light may be obtained (e.g., calculated) based on color information (e.g., color on pixel ratio (COPR) information) of an image displayed through the display. The color information of the image may be obtained from a display driver integrated circuit (DDI) for controlling the display.

An electronic device may include a plurality of displays and a plurality of DDIs for controlling each of the plurality of displays. Further, the electronic device may include a plurality of illuminance sensors to control luminance of each of the plurality of displays. Each of the plurality of DDIs may perform a function (hereinafter referred to as “COPR function”) of obtaining (e.g., calculating) color information (e.g., COPR information) of an image displayed through the display. For example, the electronic device may include a first display, a second display, a first DDI for controlling the first display, a second DDI for controlling the second display, a first illuminance sensor placed on the rear surface of the first display, and a second illuminance sensor placed behind the second display. Compensating the illuminance value obtained through the first illuminance sensor may be performed by the first DDI performing a COPR function of obtaining color information of an image displayed through the first display. Further, compensating the illuminance value obtained through the second illuminance sensor may be performed by the second DDI performing a COPR function of obtaining color information of an image displayed through the second display.

For a DDI to perform the COPR function, the DDI may further include a configuration (e.g., hardware and/or software for performing the COPR function) for performing the COPR function. Further, to use the COPR function using a DDI, a user may need to pay a usage fee (e.g., intellectual property (IP) usage cost) to another user when purchasing the DDI (or display module including the DDI). Accordingly, when an electronic device includes a plurality of DDIs, each of the plurality of DDIs may further include a configuration for performing the COPR function, and a user of the electronic device may need to pay usage fees for the plurality of DDIs.

Aspects of the disclosure are to address at least the above-mentioned problems and/or disadvantages and to provide at least the advantages described below. Accordingly, an aspect of the disclosure is to provide a method for providing color information and an electronic device supporting the same, which obtains color information of an image displayed through a display controlled by a DDI that does not support the COPR function, using a DDI that supports the COPR function, in an electronic device including a DDI supporting the COPR function and a DDI not supporting the COPR function.

Additional aspects will be set forth in part in the description which follows and, in part, will be apparent from the description, or may be learned by practice of the presented embodiments.

In accordance with an aspect of the disclosure, an electronic device is provided. The electronic device includes a first display and a first display driver integrated circuit (DDI), the first DDI being configured to control the first display and capable of obtaining color information, a second display and a second DDI configured to control the second display, a first illuminance sensor and a second illuminance sensor, the first illuminance sensor being placed under a first region of the first display, the second illuminance sensor being placed under a second region of the second display, and at least one processor operatively connected to the first display, the first DDI, the second display, the second DDI, the first illuminance sensor, and the second illuminance sensor, wherein the first DDI is configured to, based on an input for displaying an image through the second display being obtained, obtain information about the image from the second DDI, based on the obtained information about the image, obtain color information of a portion corresponding to the second region of the second display, and provide the obtained color information to the at least one processor such that the at least one processor adjusts a luminance of the second display based on the obtained color information and an illuminance value obtained through the second illuminance sensor when displaying the image through the second display.

In accordance with another aspect of the disclosure, a method for providing color information performed by an electronic device is provided. The method includes, by a first display driver integrated circuit (DDI) of the electronic device including a first display and the first DDI configured to control the first display and capable of obtaining color information, a second display and a second DDI configured to control the second display, a first illuminance sensor placed under a first region of the first display and a second illuminance sensor placed under a second region of the second display, and at least one processor, based on an input for displaying an image through the second display being obtained, obtaining information about the image from the second DDI, by the first DDI, based on the obtained information about the image, obtaining color information of a portion corresponding to the second region of the second display in the image, and providing the obtained color information to the at least one processor such that the at least one processor adjusts a luminance of the second display based on the obtained color information and an illuminance value obtained through the second illuminance sensor when displaying the image through the second display.

In accordance with another aspect of the disclosure, one or more non-transitory computer-readable storage media storing computer-executable instructions that, when executed, cause an electronic device including at least one processor to, by a first display driver integrated circuit (DDI) of the electronic device including a first display and the first DDI configured to control the first display and capable of obtaining color information, a second display and a second DDI configured to control the second display, a first illuminance sensor placed under a first region of the first display and a second illuminance sensor placed under a second region of the second display, and at least one processor, based on an input for displaying an image through the second display being obtained, obtain information about the image from the second DDI, by the first DDI, based on the obtained information about the image, obtain color information of a portion corresponding to the second region of the second display in the image, and by the first DDI, based on the obtained information about the image, and provide the obtained color information to the at least one processor such that the at least one processor adjusts a luminance of the second display based on the obtained color information and an illuminance value obtained through the second illuminance sensor when displaying the image through the second display.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a block diagram illustrating a display module according to an embodiment of the disclosure;

FIG. 3A is a view illustrating an unfolded state of an electronic device according to an embodiment of the disclosure;

FIG. 3B is a view illustrating a folded state of an electronic device according to an embodiment of the disclosure;

FIG. 4 is a cross-sectional view illustrating an electronic device according to an embodiment of the disclosure;

FIG. 5 is a block diagram illustrating an electronic device according to an embodiment of the disclosure;

FIG. 6 is a flowchart illustrating a method for providing color information according to an embodiment of the disclosure;

FIG. 7 is a flowchart illustrating a method for controlling a luminance of the second display according to an embodiment of the disclosure;

FIG. 8 is a flowchart illustrating a method for providing color information according to an embodiment of the disclosure;

FIG. 9 is a view illustrating a method for providing color information according to an embodiment of the disclosure; and

FIG. 10 is a flowchart illustrating a method for providing color information according to an embodiment of the disclosure.

Throughout the drawings, it should be noted that like reference numbers are used to depict the same or similar elements, features, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of skill in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents. It is to be understood that the singular forms “a,” “an,” and “the” include plural referents unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

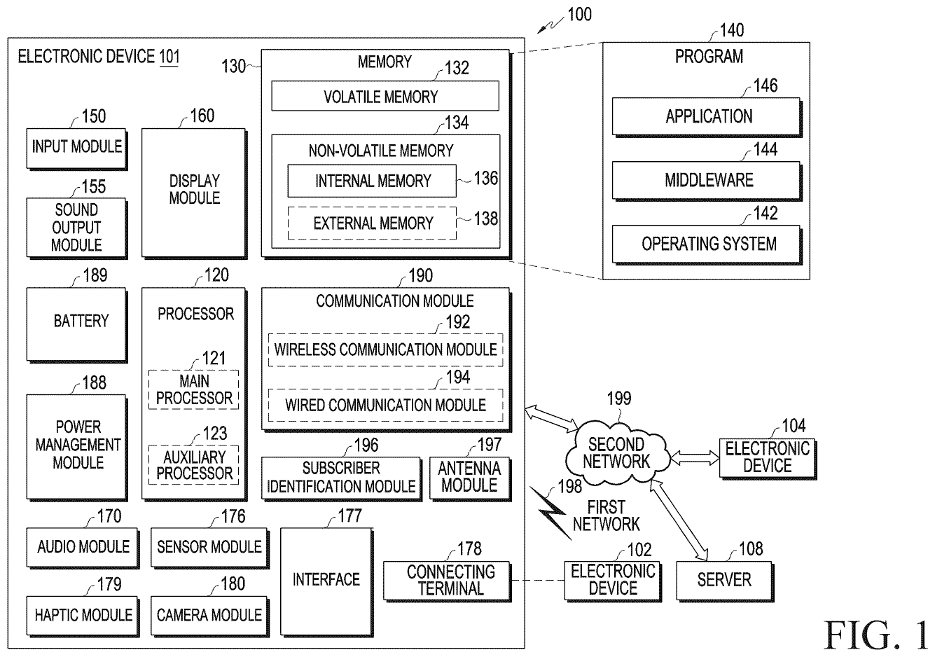

FIG. 1 is a block diagram illustrating an electronic device 101 in a network environment 100 according to an embodiment of the disclosure.

Referring to FIG. 1, the electronic device 101 in the network environment 100 may communicate with at least one of an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. According to an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wiredly) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™ wireless-fidelity (Wi-Fi) direct, or infrared data association (IrDA)) or a second network 199 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mm Wave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20 Gbps or more) for implementing eMBB, loss coverage (e.g., 164 dB or less) for implementing mMTC, or U-plane latency (e.g., 0.5 ms or less for each of downlink (DL) and uplink (UL), or a round trip of Ims or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to various embodiments, the antenna module 197 may form a mm Wave antenna module. According to an embodiment, the mm Wave antenna module may include a printed circuit board, an RFIC placed on a first surface (e.g., the bottom surface) of the printed circuit board, or adjacent to the first surface and capable of supporting a designated high-frequency band (e.g., the mmWave band), and a plurality of antennas (e.g., array antennas) placed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or server 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In another embodiment, the external electronic device 104 may include an Internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

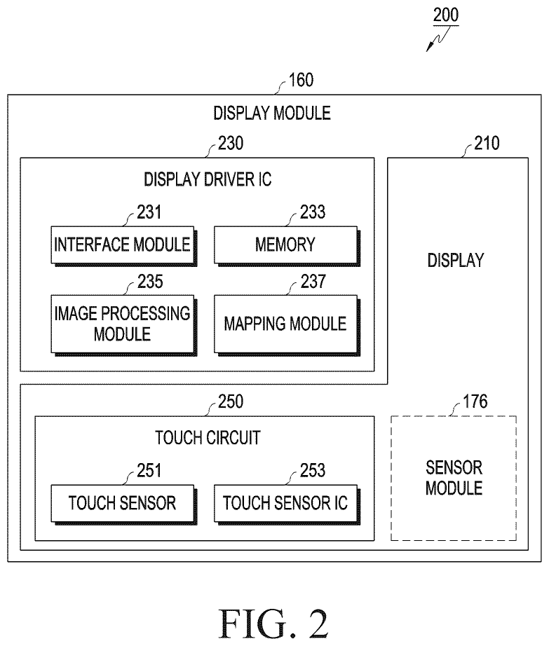

FIG. 2 is a block diagram 200 illustrating a display module 160 according to an embodiment of the disclosure.

Referring to FIG. 2, the display module 160 may include a display 210 and a display driver integrated circuit (DDI) 230 to control the display 210. The DDI 230 may include an interface module 231, memory 233 (e.g., buffer memory), an image processing module 235, or a mapping module 237. The DDI 230 may receive image information that contains image data or an image control signal corresponding to a command to control the image data from another component of the electronic device 101 via the interface module 231. For example, image information may be received from a processor (e.g., the processor 120 of FIG. 1 (e.g., the main processor 121 of FIG. 1) (e.g., an application processor)) or an auxiliary processor (e.g., the auxiliary processor 123 of FIG. 1 (e.g., a graphic processing device)) operated independently from the function of the main processor. The DDI 230 may communicate, for example, with touch circuitry 250 or the sensor module 176 via the interface module 231. The DDI 230 may also store at least part of the received image information in the memory 233, for example, on a frame by frame basis. The image processing module 235 may perform pre-processing or post-processing (e.g., adjustment of resolution, brightness, or size) with respect to at least part of the image data. According to an embodiment, the pre-processing or post-processing may be performed, for example, based at least in part on one or more characteristics of the image data or one or more characteristics of the display 210. The mapping module 237 may generate a voltage value or a current value corresponding to the image data pre-processed or post-processed by the image processing module 235. According to an embodiment, the generating of the voltage value or current value may be performed, for example, based at least in part on one or more attributes of the pixels (e.g., an array, such as a red, green, and blue (RGB) stripe or a pentile structure, of the pixels, or the size of each subpixel) of the display 210. At least some pixels of the display 210 may be driven, for example, based at least in part on the voltage value or the current value such that visual information (e.g., a text, an image, or an icon) corresponding to the image data may be displayed via the display 210.

According to an embodiment, the display module 160 may further include the touch circuitry 250. The touch circuitry 250 may include a touch sensor 251 and a touch sensor IC 253 to control the touch sensor 251. The touch sensor IC 253 may control the touch sensor 251 to sense a touch input or a hovering input with respect to a certain position on the display 210. To achieve this, for example, the touch sensor IC 253 may detect (e.g., measure) a change in a signal (e.g., a voltage, a quantity of light, a resistance, or a quantity of one or more electric charges) corresponding to the certain position on the display 210. The touch sensor IC 253 may provide input information (e.g., a position, an area, a pressure, or a time) indicative of the touch input or the hovering input detected to the processor 120. According to an embodiment, at least part (e.g., the touch sensor IC 253) of the touch circuitry 250 may be formed as part of the display 210 or the DDI 230, or as part of another component (e.g., the auxiliary processor 123) placed outside the display module 160.

According to an embodiment, the display module 160 may further include at least one sensor (e.g., a fingerprint sensor, an iris sensor, a pressure sensor, or an illuminance sensor) of the sensor module 176 or a control circuit for the at least one sensor. In such a case, the at least one sensor or the control circuit for the at least one sensor may be embedded in one portion of a component (e.g., the display 210, the DDI 230, or the touch circuitry 250)) of the display module 160. For example, when the sensor module 176 embedded in the display module 160 includes a biometric sensor (e.g., a fingerprint sensor), the biometric sensor may obtain biometric information (e.g., a fingerprint image) corresponding to a touch input received via a portion of the display 210. As another example, when the sensor module 176 embedded in the display module 160 includes a pressure sensor, the pressure sensor may obtain pressure information corresponding to a touch input received via a partial or whole area of the display 210. According to an embodiment, the touch sensor 251 or the sensor module 176 may be placed between pixels in a pixel layer of the display 210, or over or under the pixel layer.

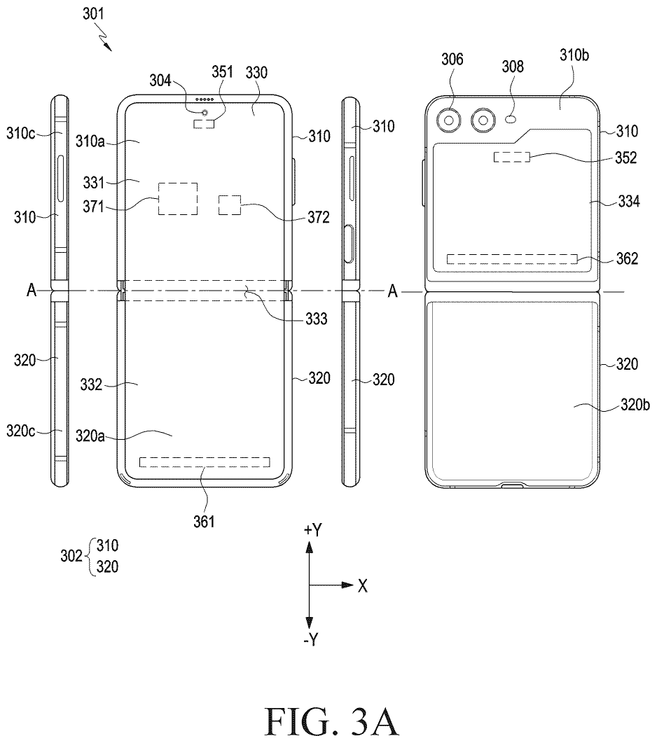

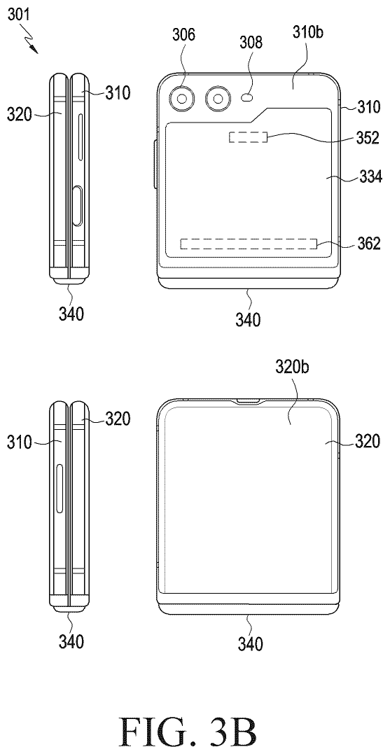

FIG. 3A is a view illustrating an unfolded state of an electronic device according to an embodiment of the disclosure.

FIG. 3B is a view illustrating a folded state of an electronic device according to an embodiment of the disclosure.

Referring to FIGS. 3A and 3B, an electronic device 301 may include a housing 302 and a flexible display (e.g., a front display 330) placed within a space formed by the housing 302. According to an embodiment, the housing 302 may be referred to as a foldable housing. According to an embodiment, the front display 330 may be referred to as a foldable display.

According to an embodiment, the housing 302 may include a first housing 310 and a second housing 320 configured to rotate about the first housing 310.

According to an embodiment, the first housing 310 and/or the second housing 320 may form a portion of the exterior of the electronic device 301. According to an embodiment, a surface through which the front display 330 is visually exposed is defined as a front surface (e.g., a first front surface 310a and a second front surface 320a) of the electronic device 301 and/or the housing 302. A surface opposite to the front surface is defined as a rear surface (e.g., a first rear surface 310b and a second rear surface 320b) of the electronic device 301. A surface surrounding at least a portion of a space between the front surface and the rear surface is defined as a side surface (e.g., a first side surface 310c and a second side surface 320c) of the electronic device 301.

According to an embodiment, the first housing 310 may be rotatably connected to the second housing 320 using a hinge structure (also referred to as “hinge” or “hinge portion”). For example, the first housing 310 and the second housing 320 may each be rotatably connected to the hinge structure. Accordingly, the electronic device 301 may be variable to a fully folded state (e.g., FIG. 3B) or a fully unfolded state (e.g., FIG. 3A). The electronic device 301 may have the first front surface 310a facing the second front surface 320a in the fully folded state, and a direction in which the first front surface 310a faces may be substantially the same as a direction in which the second front surface 320a faces in the fully unfolded state. For example, in the fully unfolded state, the first front surface 310a may be positioned on substantially the same plane as the second front surface 320a. According to an embodiment, the second housing 320 may provide a motion relative to the first housing 310.

According to an embodiment, the first housing 310 and the second housing 320 are placed on both sides of the folding axis A and be overall symmetrical in shape with respect to the folding axis A. An angle between the first housing 310 and the second housing 320 (hereinafter also referred to as “folding angle”) may be changed according to whether the state of the electronic device 301 is a fully unfolded state, a fully folded state, or an intermediate state between the fully unfolded state and the fully folded state (hereinafter referred to as “intermediate state”).

According to an embodiment, the electronic device 301 may include a hinge cover 340. At least a portion of the hinge cover 340 may be placed between the first housing 310 and the second housing 320. According to an embodiment, the hinge cover 340 may be hidden by portions of the first housing 310 and the second housing 320 or exposed to the outside of the electronic device 301 according to the state of the electronic device 301. According to an embodiment, the hinge cover 340 may protect the hinge structure (not illustrated) from external impacts to the electronic device 301. According to an embodiment, the hinge cover 340 may be interpreted as a hinge housing for protecting the hinge structure.

According to an embodiment, as illustrated in FIG. 3A, when the electronic device 301 is in a fully unfolded state, the hinge cover 340 may be hidden and not exposed by the first housing 310 and the second housing 320. As another example, as illustrated in FIG. 3B, when the electronic device 301 is in a folded state (e.g., a fully folded state), the hinge cover 340 may be exposed to the outside between the first housing 310 and the second housing 320. As another example, in an intermediate state in which the first housing 310 and the second housing 320 are folded with a certain angle, the hinge cover 340 may be partially exposed to the outside between the first housing 310 and the second housing 320. However, in this case, the exposed region may be smaller than that in the completely folded state. In an embodiment, the hinge cover 340 may include a curved surface.

In an embodiment, the front display 330 may be placed on the first housing 310 (e.g., the first front surface 310a) and the second housing 320 (e.g., the second front surface 320a). For example, the front display 330 may be placed on the first housing 310 and the second housing 320 across the hinge portion.

According to an embodiment, the front display 330 may visually provide information to the outside (e.g., a user) of the electronic device 301. The front display 330 may include, e.g., a hologram device or a projector and a control circuit for controlling the device. According to an embodiment, the front display 330 may include a touch sensor configured to detect touch or a pressure sensor configured to measure an intensity of force generated by the touch.

According to an embodiment, the front display 330 may be a display in which at least a partial region may be deformed into a flat or curved surface. For example, the front display 330 may be formed to be variable corresponding to relative motion of the second housing 320 with respect to the first housing 310. According to an embodiment, the front display 330 may include a folding region 333, a first display region 331 placed on one side (e.g., above (+Y direction)) with respect to the folding region 333, and a second display region 332 placed on the other side (e.g., below (−Y direction)). According to an embodiment, the folding region 333 may be positioned above the hinge structure. For example, at least a portion of the folding region 333 may face the hinge structure. According to an embodiment, the first display region 331 may be placed on the first housing 310, and the second display region 332 may be placed on the second housing 320. According to an embodiment, the front display 330 may be received in the first housing 310 and the second housing 320.

However, the region division of the front display 330 illustrated in FIG. 3A is exemplary, and the front display 330 may be divided into multiple regions (e.g., 4 or more or 2) according to structure or function.

Further, in the embodiment illustrated in FIG. 3A, the region of the front display 330 may be divided by the folding region 333 or folding axis (A axis) extending parallel to the X axis, but in other embodiments, the front display 330 may be divided into regions based on another folding region (e.g., a folding region parallel to the Y axis) or another folding axis (e.g., a folding axis parallel to the Y axis). According to an embodiment, the front display 330 may be combined with or placed adjacent to a touch sensing circuit, a pressure sensor capable of measuring the intensity (pressure) of touch, and/or a digitizer configured to detect a magnetic field type stylus pen.

According to an embodiment, the electronic device 301 may include a rear display 334. The rear display 334 may be placed to face a different direction from the front display 330. For example, the front display 330 may be visually exposed through the front surface (e.g., the first front surface 310a and/or the second front surface 320a) of the electronic device 301, and the rear display 334 may be visually exposed through the rear surface (e.g., the first rear surface 310b) of the electronic device 301.

According to an embodiment, the electronic device 301 may include at least one camera module 304 and 306 and a flash 308. According to an embodiment, the electronic device 301 may include a front camera module 304 exposed through the front surface (e.g., the first front surface 310a) and/or a rear camera module 306 exposed through the rear surface (e.g., the first rear surface 310b). The camera modules 304 and 306 may include one or more lenses, an image sensor, a flash, and/or an image signal processor. The flash 308 may include a light emitting diode (LED) or a xenon lamp. According to an embodiment, two or more lenses (an infrared (IR) camera, a wide-angle lens, and a telescopic lens) and image sensors may be placed on one surface of the electronic device 301. The configuration of the front camera module 304 and/or the rear camera module 306 may be identical in whole or portion to the configuration of the camera module 180 of FIGS. 1 and 2.

In an embodiment, a first illuminance sensor 351 may be placed under the front display 330, and a second illuminance sensor 352 may be placed under the rear display 334.

In an embodiment, the front display 330 may be controlled by a first DDI 361, and the rear display 334 may be controlled by a second DDI 362.

In an embodiment, the electronic device 301 may include an application processor 371 and a sensor hub processor 372.

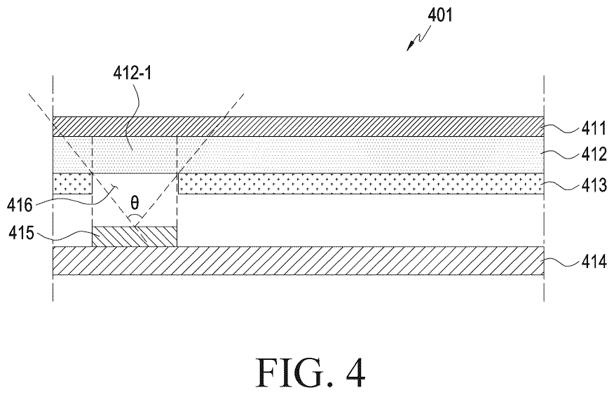

FIG. 4 is a cross-sectional view illustrating an electronic device 401 according to an embodiment of the disclosure.

Referring to FIG. 4, in an embodiment, the electronic device 401 may include a glass 411, a display panel 412, a cover panel 413, a printed circuit board (PCB) 414, and/or an illuminance sensor 415.

In an embodiment, the glass 411 is attached to the front surface of the display panel 412 and may be implemented as a flexible and transparent material (e.g., colorless polyimide (CPI)).

In an embodiment, the display panel 412 may be placed in at least a partial region of the lower portion of the glass 411. The display panel 412 may display a screen through the glass 411 formed of a transparent material.

In an embodiment, the display panel 412 may include a region 412-1 through which light is transmitted so that the illuminance sensor 415 may measure the intensity of light. In an embodiment, the illuminance sensor 415 may be placed under the region 412-1 of the display panel 412. The position and/or size of the region 412-1 of the display panel 412 may be determined based on the position and/or size of the illuminance sensor 415. For example, the position and/or size of the region 412-1 of the display panel 412 may be determined based on the field of view (θ) (FOV) of the illuminance sensor 415.

In an embodiment, the region 412-1 of the display panel 412 may be implemented to have a lower pixel density (e.g., pixels per inch (PPI)) and/or lower line density compared to other regions of the display panel 412 to enhance light transmittance.

In an embodiment, the cover panel 413 may be a layer protecting one surface of the display panel 412. The cover panel 413 may include a metal layer (e.g., a copper sheet) and/or a light blocking layer (e.g., a black embossed layer). In an embodiment, the cover panel 413 may be placed on a lower end of the display panel 412.

In an embodiment, the illuminance sensor 415 may be mounted on the PCB 414. In an embodiment, the illuminance sensor 415 may measure external illuminance by detecting external light that has passed through the glass 411 and the display panel 412. In an embodiment, since the cover panel 413 includes a light blocking layer, the cover panel 413 may not transmit external light. In order for the illuminance sensor 415 to detect external light, an opening 416 may be formed in at least a portion of the cover panel 413. The opening 416 of the cover panel 413 may be formed at a position and/or a size corresponding to the field of view θ of the illuminance sensor 415.

In an embodiment, the illuminance sensor 415 may be implemented in the form of a package further including a light emitting unit. For example, when the illuminance sensor 415 further includes a light emitting unit, the illuminance sensor 415 may operate as a proximity sensor.

In an embodiment, the illuminance sensor 415 may be included in the display panel 412. For example, at least a portion of the pixels included in the display panel 412 may include a light receiving unit to measure illuminance. In this case, the opening 416 may not be formed.

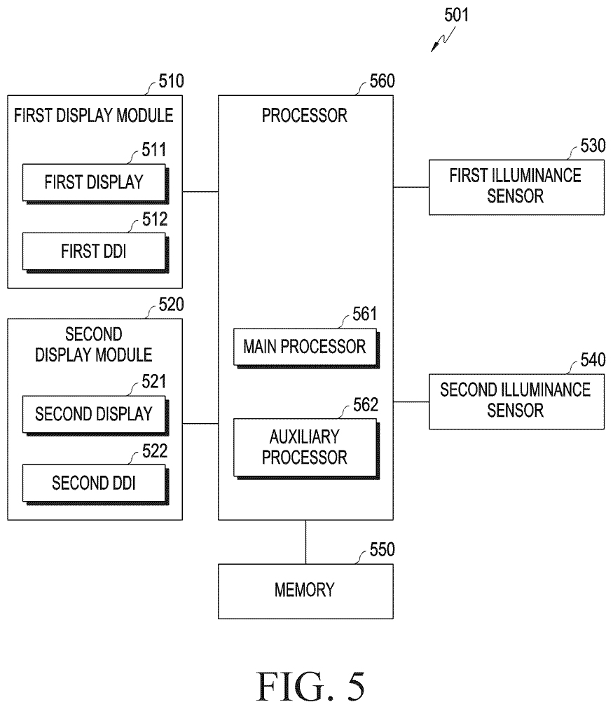

FIG. 5 is a block diagram illustrating an electronic device 501 according to an embodiment of the disclosure.

Referring to FIG. 5, in an embodiment, the electronic device 501 may be the electronic device 101 of FIG. 1, the electronic device 301 of FIGS. 3A and 3B, or the electronic device 401 of FIG. 4.

In an embodiment, the electronic device 501 may be an electronic device 501 including a plurality of displays, a plurality of DDIs controlling each of the plurality of displays, and a plurality of illuminance sensors placed under the plurality of displays. For example, the electronic device 501 may be a foldable electronic device including a front display 330, a rear display 334, a first DDI 361, a second DDI 362, a first illuminance sensor 351, and a second illuminance sensor 352, as illustrated in FIGS. 3A and 3B. However, while FIGS. 3A and 3B illustrate a foldable electronic device 501 including a first housing 310 and a second housing 320 that are rotatable by one hinge portion, this is not limiting. For example, the electronic device 501 may include an electronic device (e.g., a multi-foldable electronic device) including a plurality of hinge portions and three or more housings rotatable by the plurality of hinge portions. For example, the electronic device 501 may include all electronic devices including a plurality of displays, a plurality of DDIs controlling each of the plurality of displays, and a plurality of illuminance sensors placed under the plurality of displays, regardless of whether the electronic device 501 includes a flexible display.

In an embodiment, the electronic device 501 may include a first display module 510, a second display module 520, a first illuminance sensor 530 (referred as “first light sensor”), a second illuminance sensor 540 (referred as “second light sensor”), memory 550, and/or a processor 560.

In an embodiment, the first display module 510 may be the display module 160 of FIGS. 1 and 2.

In an embodiment, the first display module 510 may include a first display 511 and a first DDI 512.

In an embodiment, the first display 511 may be the display 210 of FIG. 2, the front display 330 of FIG. 3A, or the display panel 412 of FIG. 4.

In an embodiment, the first display 511 may include a region through which light is transmitted (hereinafter referred to as “first region of the first display”, “region of interest (ROI) of the first display”, or “sensor region of the first display”) (e.g., region 412-1 of FIG. 4) so that the first illuminance sensor 530 may measure the intensity of light.

In an embodiment, the first illuminance sensor 530 may be placed under the first region of the first display 511. In an embodiment, the first region of the first display 511 may be implemented to have a lower pixel density (e.g., pixels per inch (PPI)) and/or lower line density compared to other regions of the first display 511 to enhance light transmittance.

In an embodiment, the first DDI 512 may be the display driver IC 230 of FIG. 2, or the first DDI 361 of FIG. 3A. In an embodiment, the first DDI 512 may be a DDI for controlling the first display 511.

In an embodiment, the first DDI 512 may be a DDI capable of performing a function (hereinafter referred to as “COPR function”) of obtaining (e.g., calculating) color information (e.g., color on pixel ratio (COPR) information) of an image displayed through a display (e.g., a DDI supporting the COPR function). For example, the first DDI 512 may be a DDI including a component (e.g., hardware and/or software) capable of performing a function of obtaining color information of an image displayed through the first display 511. For example, the first DDI 512 may be a DDI capable of performing a function of obtaining color information of an image displayed (or to be displayed) through the second display 521. The COPR function performed by the first DDI 512 is described below in detail.

In an embodiment, the second display module 520 may be the display module 160 of FIGS. 1 and 2.

In an embodiment, the second display module 520 may include a second display 521 and a second DDI 522.

In an embodiment, the second display 521 may be the display 210 of FIG. 2, the rear display 334 of FIG. 3A, or the display panel 412 of FIG. 4.

In an embodiment, the second display 521 may include a region through which light is transmitted (hereinafter referred to as “second region of the second display”, “ROI of the second display”, or “sensor region of the second display”) (e.g., region 412-1 of FIG. 4) so that the second illuminance sensor 540 may measure the intensity of light.

In an embodiment, the second illuminance sensor 540 may be placed under the second region of the second display 521. In an embodiment, the second region of the second display 521 may be implemented to have a lower pixel density and/or lower line density compared to other regions of the second display 521 to enhance light transmittance.

In an embodiment, the second DDI 522 may be the display driver IC 230 of FIG. 2, or the second DDI 362 of FIGS. 3A and 3B. In an embodiment, the second DDI 522 may be a DDI for controlling the second display 521.

In an embodiment, the second DDI 522 may be a DDI that may not perform the COPR function (e.g., a DDI that does not support the COPR function). For example, the second DDI 522 may be a DDI that may not perform a function of obtaining color information of an image displayed through the second display 521. However, the disclosure is not limited thereto, and the second DDI 522 may be a DDI that supports the COPR function.

In an embodiment, the first display 511 and/or the second display 521 may be various types of displays such as a liquid crystal display (LCD) including a back light, an organic light emitting diode (OLED) display in which each pixel emits light individually, or a quantum dot light emitting diode (QLED) display.

Although FIG. 5 illustrates the electronic device 501 as including two display modules such as the first display module 510 and the second display module 520, this is not limiting. For example, the electronic device 501 may include three or more display modules. For example, the electronic device 501 may include at least one display module including a DDI supporting the COPR function and at least one display module including a DDI not supporting the COPR function.

In an embodiment, the first illuminance sensor 530 may be the first illuminance sensor 351 of FIG. 3A or the illuminance sensor 415 of FIG. 4.

In an embodiment, the first illuminance sensor 530 may be an illuminance sensor placed under the first region of the first display 511. In an embodiment, the first illuminance sensor 530 may measure external illuminance by detecting external light that has passed through the first display 511.

In an embodiment, the second illuminance sensor 540 may be the second illuminance sensor 352 of FIGS. 3A and 3B or the illuminance sensor 415 of FIG. 4.

In an embodiment, the second illuminance sensor 540 may be an illuminance sensor (e.g., the illuminance sensor 415 of FIG. 4) placed under the second region of the second display 521. In an embodiment, the second illuminance sensor 540 may measure external illuminance by detecting external light that has passed through the second display 521.

In an embodiment, the first illuminance sensor 530 and/or the second illuminance sensor 540 may include sensors using the intensity of light incident from the outside, such as a visible illuminance sensor, a proximity illuminance sensor (also referred to as “proximity sensor”), a spectrometer sensor, an ultraviolet sensor, or a color sensor. In an embodiment, the first illuminance sensor 530 and/or the second illuminance sensor 540 may include a light receiving element such as a photo diode capable of receiving light incident from the outside.

In an embodiment, the first illuminance sensor 530 and/or the second illuminance sensor 540 may be affected during illuminance measurement by the transmittance of external light through the first display 511 and/or the second display 521 and/or by screens displayed on the first display 511 and/or the second display 521. For example, when the first display 511 and/or the second display 521 is an OLED display or QLED display in which individual pixels emit light independently, the illuminance value measured by the first illuminance sensor 530 and/or the second illuminance sensor 540 may be increased by light emitted from the pixels.

Although FIG. 5 illustrates the electronic device 501 as including two illuminance sensors such as the first illuminance sensor 530 and the second illuminance sensor 540, this is not limiting. For example, the electronic device 501 may include three or more illuminance sensors. For example, when the electronic device 501 includes three or more display modules, at least one illuminance sensor may be placed behind each of the three or more display modules.

In an embodiment, the memory 550 may be the memory 130 of FIG. 1.

In an embodiment, the memory 550 may store information for performing an operation of providing color information.

In an embodiment, the processor 560 may be the processor 120 of FIG. 1.

In an embodiment, the processor 560 may perform an operation of obtaining (e.g., calculating) an illuminance value affected by external light incident from outside the electronic device 501 by subtracting an illuminance value affected by display light from an illuminance value measured by the first illuminance sensor 530 and/or the second illuminance sensor 540 (hereinafter also referred to as “operation of compensating the illuminance value”) and/or an operation of controlling (e.g., setting, or adjusting) the luminance of the display based on the obtained illuminance value.

In an embodiment, the processor 560 may include one or more processors 560 (e.g., a main processor 561 and an auxiliary processor 562) for controlling the operation of compensating the illuminance value and/or the operation of controlling the luminance of the display.

In an embodiment, the main processor 561 may be an application processor. In an embodiment, the auxiliary processor 562 may be a sensor hub processor. Operations performed by the main processor 561 and the auxiliary processor 562 is described below in detail. Although FIG. 5 illustrates the processor 560 as including a main processor 561 and an auxiliary processor 562 implemented independently of each other, this is not limiting. For example, the processor 560 may not include the auxiliary processor 562, or the main processor 561 and the auxiliary processor 562 may be implemented in an integrated form.

Although FIG. 5 illustrates the electronic device 501 as including the first display module 510, the second display module 520, the first illuminance sensor 530, the second illuminance sensor 540, the memory 550, and/or the processor 560, this is not limiting. For example, the electronic device 501 may further include one or more components included in the electronic device 101 of FIG. 1, the electronic device 301 of FIGS. 3A and 3B, or the electronic device 401 of FIG. 4.

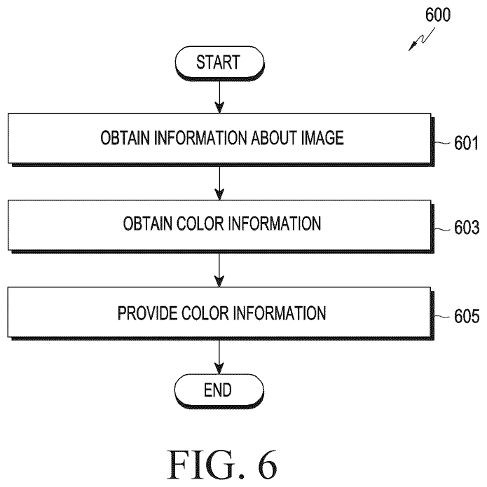

FIG. 6 is a flowchart 600 for describing a method for providing color information according to an embodiment of the disclosure.

In the following embodiment, each operation may be performed sequentially, but is not necessarily performed sequentially. For example, the order of the operations may be changed, and at least two operations may be performed in parallel.

According to an embodiment, operations 601 to 605 may be understood as being performed in the first DDI (e.g., the first DDI 512 of FIG. 5) of the electronic device (e.g., the electronic device 501 of FIG. 5).

Referring to FIG. 6, in operation 601, in an embodiment, the first DDI 512 may obtain information about the image from the second DDI 522 based on an input for displaying an image through the second display 521 being obtained.

In an embodiment, the processor 560 (e.g., the main processor 561) may obtain an input for displaying an image (e.g., a screen including text, objects, and/or images) through the second display 521. The processor 560 may provide an image to be displayed through the second display 521 (hereinafter also referred to as “first image”) to the second DDI 522 for controlling the second display 521.

In an embodiment, the second DDI 522 (e.g., a DDI not supporting the COPR function) may provide information about the first image to the first DDI 512 through the processor 560 (e.g., the main processor 561) after displaying the first image through the second display 521 (or when the first image is displayed through the second display 521) or before displaying the first image through the second display 521.

In an embodiment, the first DDI 512 (e.g., a DDI supporting the COPR function) may obtain information about the first image from the second DDI 522 through the processor 560 (e.g., the main processor 561). However, the disclosure is not limited thereto. For example, the first DDI 512 may obtain information about the first image obtained by the processor 560 from the memory 550, from the processor 560 (e.g., the main processor 561).

In an embodiment, the information about the first image may include pixel values of a portion (hereinafter referred to as “first portion of the first image” or “first portion”) (e.g., a portion displayed through the second region of the second display 521 in the first image) corresponding to the second region of the second display 521 (e.g., the ROI of the second display 521, the sensor region of the second display 521) in the first image. For example, the information about the first image may include red, green, and blue (RGB) values by coordinates of the first portion of the first image. However, the disclosure is not limited thereto, and the information about the first image may include pixel values for the first portion among pixel values before performing interpolation on the first image (e.g., pixel values of a Bayer pattern).

In an embodiment, the information about the first image may include pixel values of the first image (e.g., pixel values of the entire region of the first image) and a position of the first portion (e.g., coordinates of the first portion in the first image).

In an embodiment, the information about the first image may be obtained (e.g., generated) in the second DDI 522 and provided to the first DDI 512 through the main processor 561 (e.g., the application processor).

In operation 603, in an embodiment, the first DDI 512 may obtain color information of a portion corresponding to the second region of the second display 521 in the image based on the information about the image.

In an embodiment, the first DDI 512 may obtain color information of the first portion (e.g., the first portion displayed through the second region of the second display 521 in the first image) corresponding to the second region of the second display 521 in the first image based on the information about the first image.

In an embodiment, the first DDI 512 may obtain the color information of the first portion based on the information about the first image without displaying the first portion (or the first image) of the first image through the first display 511.

In an embodiment, when the information about the first image includes pixel values of the first image (e.g., pixel values of the entire region of the first image) and a position of the first portion (e.g., coordinates of the first portion in the first image), the first DDI 512 may obtain (e.g., calculate) pixel values of the first portion (e.g., RGB values of the first portion) based on the pixel values of the first image and the position of the first portion.

In an embodiment, the color information of the first portion may include COPR information of the first portion.

In an embodiment, the COPR information of the first portion may be information for obtaining (e.g., calculating) a display light estimation value affected by light of the second display 521, included in the illuminance value measured by the second illuminance sensor 540 while the second display 521 displays the first image.

In an embodiment, the COPR information of the first portion may be defined by Equation 1 to Equation 3 below.

$${W}_{R} = {\sum }_{i = 1}^{n} ( {C}_{r} * {R}_{i}^{α} ) / ( n * {255}^{α} ) \qquad Equation 1$$

$${W}_{G} = {\sum }_{i = 1}^{n} ( {C}_{g} * {G}_{i}^{α} ) / ( n * {255}^{α} ) \qquad Equation 2$$

$${W}_{B} = {\sum }_{i = 1}^{n} ( {C}_{b} * {B}_{i}^{α} ) / ( n * {255}^{α} ) \qquad Equation 3$$

Equation 1 to Equation 3 are merely examples to aid understanding, are not limiting, and may be modified, applied, or extended in various ways.

In an embodiment, Equation 1 to Equation 3, n may represent the number of pixels of the first portion (e.g., the number of pixels constituting the first portion). In an embodiment, in Equation 1 to Equation 3, Ri, Gi, and Bi may represent R value, G value, and B value of each pixel of the first portion. For example, Rm (when i=m), Gm, and Bm may represent the R value, G value, and B value of the mth pixel among the pixels of the first portion, respectively. In an embodiment, in Equation 1 to Equation 3, Cr, Cg, and Cb may represent coefficients (e.g., 256) for normalizing W_{R}, W_{G}, and W to values in a designated range (e.g., 0 to 256), respectively. In an embodiment, in Equation 1 to Equation 3, a may include 1 or 2.2 as a gamma value of the first display 511. In an embodiment, in Equation 1 to Equation 3, 255 may represent the maximum value of pixel values (e.g., 255 as the maximum value when the range of pixel values is 0 to 255).

In an embodiment, the COPR information of the first portion may be W_{R}, W_{G}, and WB calculated through Equation 1 to Equation 3.

In an embodiment, the first DDI 512 may obtain (e.g., calculate) COPR W of the first portion by replacing the COPR information of the first portion. For example, the first DDI 512 may obtain COPR W of the first portion using Equation 4 below.

$$W = {\sum }_{i = 1}^{n} ( {C}_{r} * {R}_{i}^{α} + {C}_{g} * {G}_{i}^{α} + {C}_{b} * {B}_{i}^{α} ) / ( 3 * n * {255}^{α} ) \qquad Equation 4$$

Equation 4 is merely an example to aid understanding, is not limiting, and may be modified, applied, or extended in various ways.

In an embodiment, in Equation 4, n may represent the number of pixels of the first portion (e.g., the number of pixels constituting the first portion). In an embodiment, in Equation 4, Ri, Gi, and Bi may represent R value, G value, and B value of each pixel of the first portion. In an embodiment, in Equation 4, Cr, Cg, and Cb may each represent coefficients (e.g., 256) for normalizing W to values in a designated range (e.g., 0 to 256). In an embodiment, in Equation 4 to Equation 3, a may include 2.2 (or 1) as a gamma value of the first display 511. In an embodiment, in Equation 4, 255 may represent the maximum value of pixel values. In an embodiment, in Equation 4, W may represent COPR W.

In an embodiment, the first DDI 512 may perform an operation of obtaining color information of the first portion of the first image displayed through the second display 521 at the same period as the period corresponding to the refresh rate of the second display 521. For example, when the refresh rate of the second display 521 is 60 Hz, the first DDI 512 may perform an operation of obtaining the color information of the first portion at a period of about 16.6 ms corresponding to 60 Hz.

In operation 605, in an embodiment, the first DDI 512 may provide the obtained color information to the processor 560.

In an embodiment, the first DDI 512 may transmit the obtained color information (e.g., W_{R}, W_{G}, and WB calculated through Equation 1 to Equation 3, or COPR W calculated through Equation 4) to the processor 560 (e.g., the auxiliary processor 562).

In an embodiment, although not illustrated in FIG. 6, the auxiliary processor 562 may measure an illuminance value through the second illuminance sensor 540 while performing at least some of operations 601 to 605 (or after the first image is displayed through the second display 521). The auxiliary processor 562 may determine a final illuminance value (hereinafter also referred to as “final illuminance value”) (e.g., an illuminance value affected by external light incident from outside the electronic device 501 by subtracting the illuminance value affected by display light from the illuminance value measured through the illuminance sensor) based on the measured illuminance value and the color information of the first portion obtained from the first DDI 512.

In an embodiment, the processor 560 (e.g., the main processor 561) may set (e.g., adjust) the luminance of the second display 521 to a luminance (e.g., luminance level) corresponding to the final illuminance value determined by the processor 560 (e.g., the auxiliary processor 562).

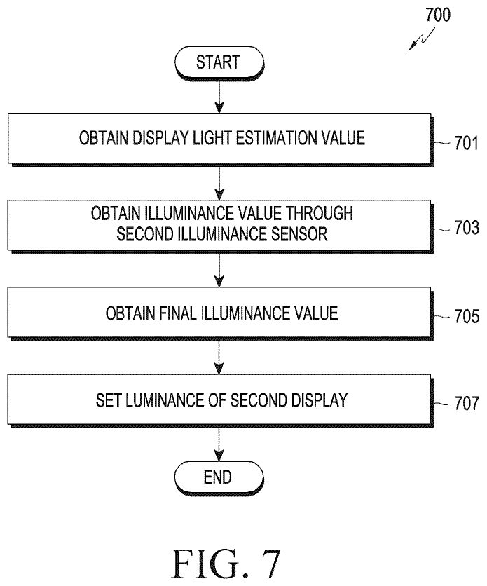

Hereinafter, referring to FIG. 7, operations of the processor 560 (e.g., the auxiliary processor 562 and the main processor 561) performed after the color information of the first portion is obtained is described in more detail.

In an embodiment, although not illustrated in FIG. 6, the second DDI 522 may display the first image through the second display 521. For example, the second DDI 522 may display the first image through the second display 521 before performing at least some of the operations described through FIG. 6 (e.g., in response to an input for displaying an image through the second display 521 being obtained), while performing at least some of the operations described through FIG. 6 (e.g., while performing operations 601 to 605), or after performing at least some of the operations described through FIG. 6 (e.g., after the luminance of the second display 521 is set to a luminance corresponding to the final illuminance value).

FIG. 7 is a flowchart 700 for describing a method for controlling the luminance of the second display 521 according to an embodiment of the disclosure.

In the following embodiment, each operation may be performed sequentially, but is not necessarily performed sequentially. For example, the order of the operations may be changed, and at least two operations may be performed in parallel.

According to an embodiment, operations 701 to 707 may be understood as being performed in the processor (e.g., the processor 560 of FIG. 5) of the electronic device (e.g., the electronic device 501 of FIG. 5).

In an embodiment, the operations of FIG. 7 may be performed after performing the operations of FIG. 6 and/or while performing the operations of FIG. 6.

Referring to FIG. 7, in operation 701, in an embodiment, the processor 560 (e.g., the auxiliary processor 562) may obtain a display light estimation value (e.g., a display light estimation value of the second display 521) based on the color information of the first portion obtained from the first DDI 512.

In an embodiment, the processor 560 (e.g., the auxiliary processor 562) may obtain the color information of the first portion of the first image displayed through the second display 521 from the first DDI 512.

In an embodiment, the processor 560 (e.g., the auxiliary processor 562) may obtain (e.g., calculate) COPR W of the first portion based on the color information of the first portion.

In an embodiment, when the color information of the first portion is W_{R}, W_{G}, and WB calculated through Equation 1 to Equation 3 and 2.2 is used as the gamma value (a) of the second display 521 in Equation 1 to Equation 3, the processor 560 may obtain COPR W of the first portion by dividing the sum of W_{R}, W_{G}, and WB by 3, as in Equation 5 below.

$$COPR W = ( {W}_{R} + {W}_{G} + {W}_{B} ) / 3 \qquad Equation 5$$

Equation 5 is merely an example to aid understanding, is not limiting, and may be modified, applied, or extended in various ways.

In an embodiment, when W (e.g., COPR W) calculated through Equation 4 replacing the color information of the first portion is obtained from the first DDI 512, the processor 560 may identify W obtained from the first DDI 512 as COPR W without performing an operation of calculating COPR W of the first portion.

In an embodiment, when the color information of the first portion is W_{R}, W_{G}, and WB calculated through Equation 1 to Equation 3 and 1 is used as the gamma value (a) of the second display 521 in Equation 1 to Equation 3, the processor 560 may obtain COPR W of the first portion using Equation 6 below.

$$COPR W = a * {( {W}_{R} )}^{2.2} + b * {( {W}_{G} )}^{2.2} + c * {( {W}_{B} )}^{2.2} \qquad Equation 6$$

Equation 6 is merely an example to aid understanding, is not limiting, and may be modified, applied, or extended in various ways.

In an embodiment, in Equation 6, W_{R}, W_{G}, and WB may represent W_{R}, W_{G}, and WB calculated through Equation 1 to Equation 3 with the gamma value (a) of the second display 521 set to 1. In an embodiment, in Equation 6, 2.2 may represent the gamma value (a) of the second display 521. In an embodiment, in Equation 6, a, b, and c may be coefficients for calculating COPR W.

In an embodiment, after COPR W of the first portion is obtained, the processor 560 (e.g., the auxiliary processor 562) may obtain the display light estimation value of the second display 521 (also referred to as “COPR Lux”) using Equation 7 and Equation 8.

$$brightness coefficient = d * ( luminance code ) {2}^{} + e * ( luminance code ) + f \qquad Equation 7$$

Equation 7 is merely an example to aid understanding, is not limiting, and may be modified, applied, or extended in various ways.

In an embodiment, in Equation 7, the luminance code may be a value corresponding to a current luminance value of the second display 521. For example, luminance from minimum luminance to maximum luminance of the second display 521 may be classified into a designated number (e.g., 256) of multiple luminance ranges according to the magnitude of luminance. The luminance codes may be set to correspond to the classified luminance ranges, respectively. In an embodiment, in Equation 7, d, e, and f may be coefficients for calculating a brightness coefficient. In Equation 7, the brightness coefficient is represented as a quadratic equation for the luminance code, but the disclosure is not limited thereto.

$$display light estimation value = ( COPR W ) * ( brightness coefficient ) \qquad Equation 8$$

Equation 8 is merely an example to aid understanding, is not limiting, and may be modified, applied, or extended in various ways.

In an embodiment, as illustrated in Equation 8, the display light estimation value of the second display 521 may be calculated by multiplying COPR W of the first portion by the brightness coefficient calculated using Equation 7.

In operation 703, in an embodiment, the processor 560 (e.g., the auxiliary processor 562) may obtain an illuminance value through the second illuminance sensor 540. For example, the processor 560 may measure an illuminance value through the second illuminance sensor 540 while the first image is displayed through the second display 521.

In operation 705, in an embodiment, the processor 560 (e.g., the auxiliary processor 562) may obtain (e.g., calculate) a final illuminance value based on the display light estimation value and the illuminance value obtained through the second illuminance sensor 540. For example, the processor 560 may obtain (e.g., calculate) a final illuminance value based on the display light estimation value obtained through operation 701 and the illuminance value obtained through operation 703.

In an embodiment, the processor 560 may obtain (e.g., calculate) the final illuminance value (e.g., the final illuminance value of the second illuminance sensor 540) using Equation 9 below based on the display light estimation value and the illuminance value obtained through the second illuminance sensor 540.

$$final illuminance value = ( illuminance value measured through second illuminance sensor ) * ( calibration constant ) - ( display light estimation value ) \qquad Equation 9$$

Equation 9 is merely an example to aid understanding, is not limiting, and may be modified, applied, or extended in various ways.

In an embodiment, in Equation 9, the calibration constant is a value calculated by calibration performed in a process step of mounting a display and an illuminance sensor in an electronic device, and may be a value for correcting the illuminance value measured through the second illuminance sensor 540. In an embodiment, in Equation 9, the display light estimation value may represent the display light estimation value of the second display 521.

In operation 707, in an embodiment, the processor 560 (e.g., the main processor 561) may set (or control) the luminance of the second display 521 based on the final illuminance value.

In an embodiment, the processor 560 may identify a luminance (e.g., luminance level) corresponding to the final illuminance value (e.g., the final illuminance value of the second illuminance sensor 540 obtained through operation 705). For example, the processor 560 may identify a luminance level corresponding to the final illuminance value within a luminance look-up table in which illuminance values and luminance levels (or luminance codes) are mapped.

In an embodiment, the processor 560 may set (e.g., adjust) the identified luminance level as the luminance level of the second display 521.

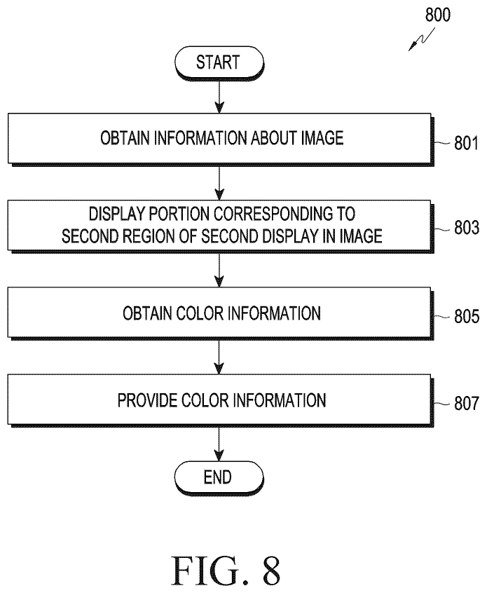

FIG. 8 is a flowchart 800 for describing a method for providing color information according to an embodiment of the disclosure.

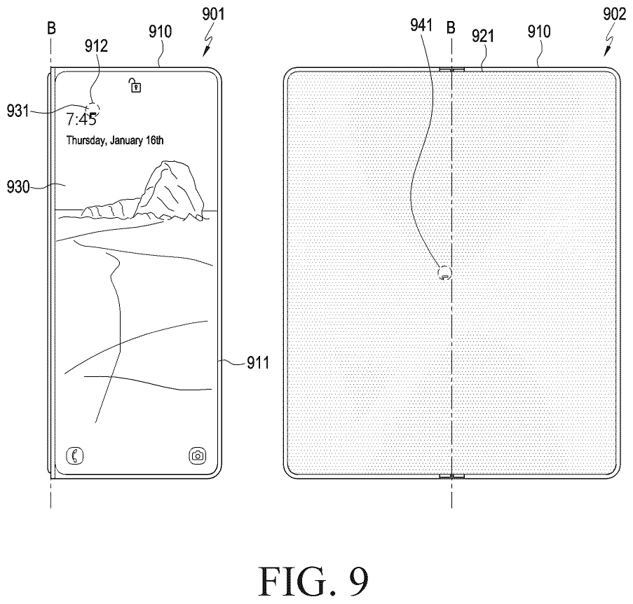

FIG. 9 is a view illustrating a method for providing color information according to an embodiment of the disclosure.

In the following embodiment, each operation may be performed sequentially, but is not necessarily performed sequentially. For example, the order of the operations may be changed, and at least two operations may be performed in parallel.

According to an embodiment, operations 801 to 807 may be understood as being performed in the first DDI (e.g., the first DDI 512 of FIG. 5) of the electronic device (e.g., the electronic device 501 of FIG. 5).

Referring to FIGS. 8 and 9, in operation 801, in an embodiment, the first DDI 512 may obtain information about the image from the second DDI 522 based on an input for displaying an image through the second display 521 being obtained.

Operation 801 is at least partially identical or similar to operation 601 of FIG. 6, so a detailed description is omitted.

In operation 803, in an embodiment, the first DDI 512 may display a portion corresponding to the second region of the second display 521 in the image through the first display 511.

In an embodiment, the first DDI 512 may display the first portion of the first image through the first display 511 before obtaining the color information of the first portion of the first image, based on obtaining the information about the first image from the second DDI 522. For example, the first DDI 512 may be a DDI configured to perform the COPR function while displaying an image through the first display 511 (or after displaying an image through the first display 511). In this case, the first DDI 512 may perform an operation of obtaining the color information of the first portion of the first image after displaying the first portion of the first image through the first display 511.

In an embodiment, the first DDI 512 may display the first portion of the first image through the first display 511. For example, reference numeral 901 of FIG. 9 may represent a foldable electronic device 910 in a fully folded state, and reference numeral 903 in FIG. 9 may represent a foldable electronic device 910 in a fully unfolded state. The foldable electronic device 910 may be a foldable electronic device that may be folded or unfolded based on a folding axis B. The foldable electronic device 910 may include a first display 511 (e.g., a first display 921), a second display 521 (e.g., a second display 911), a first DDI 512 that supports the COPR function and controls the first display 511, a second DDI 522 that does not support the COPR function and controls the second display 521, a first illuminance sensor 530 placed under the first display 511, and a second illuminance sensor 540 placed under the second display 521. In reference numeral 901, the second DDI 522 may display a first image 930 (e.g., a lock screen) through the second display 911. The second DDI 522 may provide information about a first portion 931 (or the first image 930) displayed in the second region 912 of the second display 911 within the first image 930 to the first DDI 512. In reference numeral 902, the first DDI 512 may display the first portion 931 (e.g., the same image 941 as the first portion 931) displayed in the second region 912 of the second display 911 through a designated region of the first display 921.

In an embodiment, when displaying the first portion of the first image through the first display 511, the first DDI 512 may display a black image through the remaining region except for the region displaying the first portion of the first image within the first display 511, as illustrated in reference numeral 902.

In an embodiment, the first DDI 512 may display the first portion of the first image through the first display 511 at the minimum luminance of the first display 511. For example, the first DDI 512 may set the luminance of the first display 511 to a settable minimum luminance and then display the first portion of the first image through the first display 511.

In an embodiment, the first DDI 512 may control the electronic device 501 to operate in a low power mode while displaying the first portion of the first image through the first display 511.

In an embodiment, the first DDI 512 may set (e.g., adjust) the refresh rate for displaying the first portion of the first image through the first display 511 to a lower refresh rate while displaying the first portion of the first image through the first display 511. For example, when the refresh rate where the first display 511 displays an image is currently set to 60 Hz, the first DDI 512 may set the refresh rate where the first display 511 displays the first image to a refresh rate lower than 60 Hz (e.g., 48 Hz, 30 Hz, 24 Hz, 10 Hz, or 1 Hz) when displaying the first portion of the first image through the first display 511.

In an embodiment, the first DDI 512 may set the refresh rate for displaying the first portion of the first image through the first display 511 to the lowest refresh rate which can be set by the first display 511 while displaying the first portion of the first image through the first display 511. For example, when the refresh rate where the first display 511 displays an image is currently set to 60 Hz, the first DDI 512 may set the refresh rate where the first display 511 displays the first image to the lowest refresh rate (e.g., 1 Hz) among the settable refresh rates of the first display 511 (e.g., 120 Hz, 96 Hz, 60 Hz, 30 Hz, 24 Hz, 10 Hz, and 1 Hz) when displaying the first portion of the first image through the first display 511.

In an embodiment, the first DDI 512 may display the first portion of the first image through the first display 511 using the same number of pixels as the number of pixels of the first portion of the first image. For example, the first DDI 512 may set the number of pixels of the first portion displayed through the first display 511 to be the same as the number of pixels constituting the first portion (e.g., the first portion 931 of FIG. 9) when displaying the first portion through the second display 521 and the number of pixels constituting the first portion (e.g., the image 941 of FIG. 9) when displaying the first portion through the first display 511. For example, the first DDI 512 may set the resolution of the first portion displayed through the first display 511 such that the resolution of the first portion (e.g., the first portion 931 of FIG. 9) when displaying the first portion through the second display 521 and the resolution of the first portion (e.g., the image 941 of FIG. 9) when displaying the first portion through the first display 511 are the same. However, the disclosure is not limited thereto. For example, the first DDI 512 may display the first portion of the first image through the first display 511 using fewer pixels than the number of pixels of the first portion of the first image. In this case, the color information of the first portion to be obtained by the first DDI 512 may be less accurate compared to when displaying the first portion of the first image through the first display 511 using the same number of pixels as the number of pixels of the first portion of the first image. For example, the first DDI 512 may display the first portion of the first image through the first display 511 using more pixels than the number of pixels of the first portion of the first image. In this case, more power may be consumed compared to when displaying the first portion of the first image through the first display 511 using the same number of pixels as the number of pixels of the first portion of the first image.

In an embodiment, when the first DDI 512 displays the first portion of the first image through the first display 511 using the same number of pixels as the number of pixels of the first portion of the first image, the form (e.g., size and/or aspect ratio) of the first portion displayed through the second display 521 (e.g., the first portion 931 of FIG. 9) and the form (e.g., size and/or aspect ratio) of the first portion displayed through the first display 511 (e.g., image 941) may be the same or different.

Although operation 803 has been described as displaying the portion corresponding to the second region of the second display 521 in the image through the first display 511, this is not limiting. For example, the first DDI 512 may display the entire first image through the first display 511.

In operation 805, in an embodiment, the first DDI 512 may obtain color information of a portion corresponding to the second region of the second display 521 in the image based on the information about the image. For example, the first DDI 512 may obtain color information of the portion corresponding to the second region of the second display 521 in the image based on the information about the image while the first portion of the first image is displayed through the first display 511.

Since operation 805 is at least partially the same as or similar to operation 603 of FIG. 6, a detailed description thereof will be omitted.

In operation 807, in an embodiment, the first DDI 512 may provide the obtained color information to the processor 560.

Since operation 807 is at least partially the same or similar to the operation 605 of FIG. 6, no detailed description thereof is presented below.

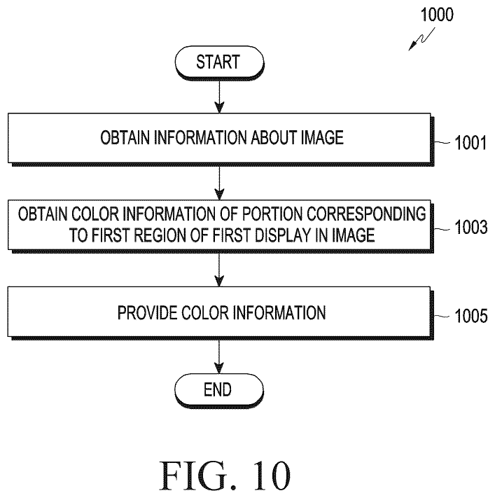

FIG. 10 is a flowchart 1000 for describing a method for providing color information according to an embodiment of the disclosure.

In the following embodiment, each operation may be performed sequentially, but is not necessarily performed sequentially. For example, the order of the operations may be changed, and at least two operations may be performed in parallel.

According to an embodiment, operations 1001 to 1005 may be understood as being performed in the first DDI (e.g., the first DDI 512 of FIG. 5) of the electronic device (e.g., the electronic device 501 of FIG. 5).

Referring to FIG. 10, in operation 1001, in an embodiment, the first DDI 512 may obtain information about the image based on an input for displaying an image through the first display 511 being obtained.

In an embodiment, the processor 560 (e.g., the main processor 561) may obtain an input for displaying an image (e.g., a screen including text, objects, and/or images) through the first display 511. The processor 560 may provide an image to be displayed through the first display 511 (hereinafter also referred to as “second image”) to the first DDI 512.

In an embodiment, the first DDI 512 may obtain the second image from the processor 560.

In an embodiment, the first DDI 512 may display the second image through the first display 511 based on obtaining the second image.

In an embodiment, the first DDI 512 may obtain information about a portion (hereinafter referred to as “second portion of the second image” or “second portion”) corresponding to the first region of the first display 511 in the second image (e.g., a portion displayed through the first region of the first display 511 in the second image) based on obtaining the second image. For example, the first DDI 512 may obtain information about the second portion including RGB values by coordinates of the second portion of the second image.

In operation 1003, in an embodiment, the first DDI 512 may obtain color information of the portion corresponding to the first region of the first display 511 in the image based on the information about the image.

In an embodiment, the first DDI 512 may obtain color information (e.g., COPR information of the second portion) of the second portion of the second image based on the information about the second portion of the second image.

In an embodiment, the operation of the first DDI 512 obtaining the COPR information of the second portion is at least partially identical or similar to the operation of the first DDI 512 obtaining the COPR information of the first portion in operation 603 of FIG. 6, so detailed description is omitted.

In operation 1005, in an embodiment, the first DDI 512 may provide the obtained color information to the processor 560. For example, the first DDI 512 may provide the color information of the second portion to the processor 560 (e.g., the auxiliary processor 562).

In an embodiment, although not illustrated in FIG. 10, the auxiliary processor 562 may measure an illuminance value through the first illuminance sensor 530 while performing at least some of operations 1001 to 1005 (or after the second image is displayed through the first display 511). The auxiliary processor 562 may determine a final illuminance value of the first illuminance sensor 530 based on the measured illuminance value and the color information of the second portion obtained from the first DDI 512.

In an embodiment, the processor 560 (e.g., the main processor 561) may set (e.g., adjust) the luminance of the first display 511 to a luminance (e.g., luminance level) corresponding to the final illuminance value determined by the processor 560 (e.g., the auxiliary processor 562).

An electronic device 501 according to an embodiment may include a first display 511 and a first DDI 512 configured to control the first display 511 and capable of obtaining color information, a second display 521 and a second DDI 522 configured to control the second display 521, a first illuminance sensor 530 placed under a first region of the first display 511 and a second illuminance sensor 540 placed under a second region of the second display 521, at least one processor 560 operatively connected to the first display 511, the first DDI 512, the second display 521, the second DDI 522, the first illuminance sensor 530, and the second illuminance sensor 540. The first DDI 512 may be configured to obtain information about the image from the second DDI 522 based on an input for displaying an image through the second display 521 being obtained. The first DDI 512 may be configured to obtain color information of a portion corresponding to the second region of the second display 521 in the image based on the obtained information about the image. The first DDI 512 may be configured to provide the obtained color information to the at least one processor 560 such that the at least one processor 560 adjusts a luminance of the second display 521 based on the obtained color information and an illuminance value obtained through the second illuminance sensor 540 when displaying the image through the second display 521.

In an embodiment, the second DDI 522 may include a DDI that may not obtain color information related to the second region.

In an embodiment, the first DDI 512 may be configured to obtain information about the image displayed through the second display 521 from the second DDI 522 when the image is displayed through the second display 521.

In an embodiment, the information about the image may include values of pixels of the portion corresponding to the second region of the second display 521 in the image, or values of pixels of the image and positions of the portion in the image.

In an embodiment, the color information of the portion may include color on pixel ratio (COPR) information of the portion.

In an embodiment, the at least one processor 560 may determine an illuminance value obtained through the second illuminance sensor 540 by light of the second display 521 when displaying the image through the second display 521 based on the obtained color information. The at least one processor 560 may be configured to obtain the illuminance value through the second illuminance sensor 540 based on displaying the image through the second display 521. The at least one processor 560 may be configured to obtain a final illuminance value based on the determined illuminance value and the obtained illuminance value. The at least one processor 560 may be configured to set a luminance corresponding to the final illuminance value as the luminance of the second display 521.

In an embodiment, the first DDI 512 may be configured to display the portion corresponding to the second region of the second display 521 in the image through the first display 511.

In an embodiment, the first DDI 512 may be configured to display the portion corresponding to the second region of the second display 521 in the image through the first display 511 at a minimum luminance of the first display 511.

In an embodiment, the at least one processor 560 may be configured to control the electronic device 501 to operate in a low power mode while displaying the portion corresponding to the second region of the second display 521 in the image through the first display 511.

In an embodiment, the first DDI 512 may be configured to display the portion through the first display 511 using the same number of pixels as the number of pixels of the portion displayed through the second display 521.

In an embodiment, a method for providing color information in an electronic device 501 may comprise obtaining information about the image from the second DDI 522 based on an input for displaying an image through the second display 521 being obtained, by the first DDI 512, based on the obtained information about the image. The method may comprise obtaining color information of the portion corresponding to the second region of the second display 521 in the image based on the obtained information about the image, by the first DDI 512. The method may comprise providing the obtained color information to the at least one processor 560 such that the at least one processor 560 adjusts a luminance of the second display 521 based on the obtained color information and an illuminance value obtained through the second illuminance sensor 540 when displaying the image through the second display 521.

In an embodiment, the second DDI 522 may include a DDI that may not obtain color information related to the second region.

In an embodiment, obtaining the information about the image from the second DDI 522 may comprise obtaining, from the second DDI 522, information about the image displayed through the second display 521 when the image is displayed through the second display 521, by the first DDI 512.

In an embodiment, the information about the image may include values of pixels of the portion corresponding to the second region of the second display 521 in the image, or values of pixels of the image and positions of the portion in the image.

In an embodiment, the color information of the portion may include COPR information of the portion.

In an embodiment, the method may further include comprise determining an illuminance value obtained through the second illuminance sensor 540 by light of the second display 521 when displaying the image through the second display 521 based on the obtained color information, by the at least one processor 560. The method may further comprise obtaining the illuminance value through the second illuminance sensor 540 based on displaying the image through the second display 521, by the at least one processor 560. The method may further comprise obtaining a final illuminance value based on the determined illuminance value and the obtained illuminance value, by the at least one processor 560. The method may further comprise setting a luminance corresponding to the final illuminance value as the luminance of the second display 521, by the at least one processor 560.

In an embodiment, the method may further comprise displaying the portion corresponding to the second region of the second display 521 in the image through the first display 511, by the first DDI 512.

In an embodiment, displaying the portion corresponding to the second region of the second display 521 in the image through the first display 511 may comprise displaying the portion corresponding to the second region of the second display 521 in the image through the first display 511 at a minimum luminance of the first display 511, by the first DDI 512.

In an embodiment, displaying the portion corresponding to the second region of the second display 521 in the image through the first display 511 may include controlling the electronic device 501 to operate in a low power mode while displaying the portion corresponding to the second region of the second display 521 in the image through the first display 511, by the at least one processor 560.

In an embodiment, in a non-transitory computer-readable medium having recorded thereon computer-executable instructions, the computer-executable instructions may, when executed, cause an electronic device 501 including at least one processor 560 to obtain information about the image from the second DDI 522 based on an input for displaying an image through the second display 521 being obtained, by the first DDI 512. The computer-executable instructions may, when executed, cause an electronic device 501 including at least one processor 560 to obtain color information of the portion corresponding to the second region of the second display 521 in the image based on the obtained information about the image, by the first DDI 512. The computer-executable instructions may, when executed, cause an electronic device 501 including at least one processor 560 to provide the obtained color information to the at least one processor 560 such that the at least one processor 560 adjusts a luminance of the second display 521 based on the obtained color information and an illuminance value obtained through the second illuminance sensor 540 when displaying the image through the second display 521, by the first DDI 512.

Further, the structure of the data used in embodiments of the disclosure may be recorded in a computer-readable recording medium via various means. The computer-readable recording medium includes a storage medium, such as a magnetic storage medium (e.g., a read only memory (ROM), a floppy disc, or a hard disc) or an optical reading medium (e.g., a compact disc read only memory (CD-ROM) or a digital versatile disc (DVD)).

The electronic device according to an embodiment of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

It should be appreciated that various embodiments of the disclosure and the terms used therein are not intended to limit the technological features set forth herein to particular embodiments and include various changes, equivalents, or replacements for a corresponding embodiment. In connection to the description of the drawings, similar reference numerals may be used for similar or related components. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspects (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately placed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

It will be appreciated that various embodiments of the disclosure according to the claims and description in the specification can be realized in the form of hardware, software or a combination of hardware and software.

Any such software may be stored in non-transitory computer readable storage media. The non-transitory computer readable storage media store one or more computer programs (software modules), the one or more computer programs include computer-executable instructions that, when executed by one or more processors of an electronic device individually or collectively, cause the electronic device to perform a method of the disclosure.

Any such software may be stored in the form of volatile or non-volatile storage such as, for example, a storage device like read only memory (ROM), whether erasable or rewritable or not, or in the form of memory such as, for example, random access memory (RAM), memory chips, device or integrated circuits or on an optically or magnetically readable medium such as, for example, a compact disk (CD), digital versatile disc (DVD), magnetic disk or magnetic tape or the like. It will be appreciated that the storage devices and storage media are various embodiments of non-transitory machine-readable storage that are suitable for storing a computer program or computer programs comprising instructions that, when executed, implement various embodiments of the disclosure. Accordingly, various embodiments provide a program comprising code for implementing apparatus or a method as claimed in any one of the claims of this specification and a non-transitory machine-readable storage storing such a program.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a first display and a first display driver integrated circuit (DDI), the first DDI being configured to control the first display and capable of obtaining color information;
a second display and a second DDI configured to control the second display;
a first illuminance sensor and a second illuminance sensor, the first illuminance sensor being placed under a first region of the first display, the second illuminance sensor being placed under a second region of the second display; and
at least one processor operatively connected to the first display, the first DDI, the second display, the second DDI, the first illuminance sensor, and the second illuminance sensor,
wherein the first DDI is configured to:
based on an input for displaying an image through the second display being obtained, obtain information about the image from the second DDI,
based on the obtained information about the image, obtain color information of a portion corresponding to the second region of the second display in the image, and
provide the obtained color information to the at least one processor such that the at least one processor adjusts a luminance of the second display based on the obtained color information and an illuminance value obtained through the second illuminance sensor when displaying the image through the second display.

2. The electronic device of claim 1, wherein the second DDI includes a DDI which is incapable of obtaining the color information related to the second region.

3. The electronic device of claim 1, wherein the first DDI is configured to:
when the image is displayed through the second display, obtain, from the second DDI, information about the image displayed through the second display.

4. The electronic device of claim 1, wherein the information about the image includes values of pixels of the portion corresponding to the second region of the second display in the image, or values of pixels of the image and positions of the portion in the image.

5. The electronic device of claim 1, wherein the color information of the portion includes color on pixel ratio (COPR) information of the portion.

6. The electronic device of claim 1, wherein the at least one processor is configured to:
based on the obtained color information, determine an illuminance value obtained by light emitted from the second display through the second illuminance sensor when the image is displayed through the second display,
based on displaying the image through the second display, obtain the illuminance value through the second illuminance sensor,
based on the determined illuminance value and the obtained illuminance value, obtain a final illuminance value, and
set a luminance corresponding to the final illuminance value as the luminance of the second display.

7. The electronic device of claim 1, wherein the first DDI is configured to:
display, through the first display, the portion corresponding to the second region of the second display in the image.

8. The electronic device of claim 7, wherein the first DDI is configured to:
display, through the first display, the portion corresponding to the second region of the second display in the image, at a minimum luminance of the first display.

9. The electronic device of claim 7, further comprising:
memory storing instructions that, when executed by the at least one processor individually or collectively, cause the electronic device to:
control the electronic device to operate in a low power mode while displaying, through the first display, the portion corresponding to the second region of the second display in the image.

10. The electronic device of claim 7, wherein the first DDI is configured to:
display, using a number of pixels identical to a number of pixels of the portion displayed through the second display, the portion through the first display.

11. A method for providing color information performed by an electronic device, the method comprising:
by a first display driver integrated circuit (DDI) of the electronic device comprising:
a first display and the first DDI configured to control the first display and capable of obtaining color information,
a second display and a second DDI configured to control the second display,
a first illuminance sensor placed under a first region of the first display and a second illuminance sensor placed under a second region of the second display, and
at least one processor, based on an input for displaying an image through the second display being obtained, obtaining information about the image from the second DDI;
by the first DDI, based on the obtained information about the image, obtaining color information of a portion corresponding to the second region of the second display in the image; and
providing the obtained color information to the at least one processor such that the at least one processor adjusts a luminance of the second display based on the obtained color information and an illuminance value obtained through the second illuminance sensor when displaying the image through the second display.

12. The method of claim 11, wherein the second DDI includes a DDI which is incapable of obtaining the color information related to the second region.

13. The method of claim 11, wherein obtaining the information about the image from the second DDI comprises:
by the first DDI, when the image is displayed through the second display, obtaining, from the second DDI, information about the image displayed through the second display.

14. The method of claim 11, wherein the information about the image includes values of pixels of the portion corresponding to the second region of the second display in the image, or values of pixels of the image and positions of the portion in the image.

15. The method of claim 11, wherein the color information of the portion includes color on pixel ratio (COPR) information of the portion.

16. The method of claim 11, further comprising:
based on the obtained color information, determining, by the at least one processor, an illuminance value obtained by light emitted from the second display through the second illuminance sensor when the image is displayed through the second display;
based on displaying the image through the second display, obtaining, by the at least one processor, the illuminance value through the second illuminance sensor;
based on the determined illuminance value and the obtained illuminance value, obtaining, by the at least one processor, a final illuminance value; and
setting, by the at least one processor, a luminance corresponding to the final illuminance value as the luminance of the second display.

17. The method of claim 11, further comprising:
displaying, by the first DDI, through the first display, the portion corresponding to the second region of the second display in the image.

18. The method of claim 17, further comprising:
displaying, by the first DDI, through the first display, the portion corresponding to the second region of the second display in the image, at a minimum luminance of the first display.

19. The method of claim 17, further comprising:
controlling, by the at least one processor, the electronic device to operate in a low power mode while displaying, through the first display, the portion corresponding to the second region of the second display in the image.

20. One or more non-transitory computer-readable storage media storing computer-executable instructions that, when executed, cause an electronic device including at least one processor to:
by a first display driver integrated circuit (DDI) of the electronic device comprising:
a first display and the first DDI configured to control the first display and capable of obtaining color information,
a second display and a second DDI configured to control the second display,
a first illuminance sensor placed under a first region of the first display and a second illuminance sensor placed under a second region of the second display, and
at least one processor, based on an input for displaying an image through the second display being obtained, obtain information about the image from the second DDI;
by the first DDI, based on the obtained information about the image, obtain color information of a portion corresponding to the second region of the second display in the image; and
by the first DDI, provide the obtained color information to the at least one processor such that the at least one processor adjusts a luminance of the second display based on the obtained color information and an illuminance value obtained through the second illuminance sensor when displaying the image through the second display.
